(19) United States
(12) Patent Application Publication
(10) Pub. No.: US 2023/0325760 A1
(43) Pub. Date: Oct. 12, 2023

(54) SYSTEMS AND METHODS FOR PROVIDING A RENDEZVOUS SERVICE FOR PICK-UP OR DELIVERY

(71) Applicant: Ford Global Technologies, LLC, Dearborn, MI (US)

(72) Inventors: Stephanie Miello, Wyandotte, MI (US); Don Conroy, Grosse Ile, MI (US); Ronald Oppat, Northville, MI (US); Peter Nikolajevs, Dearborn, MI (US); Fiona Gronowicz, Plymouth, MI (US)

(73) Assignee: Ford Global Technologies, LLC, Dearborn, MI (US)

(21) Appl. No.: 17/658,628

(22) Filed: Apr. 8, 2022

(51) Int. Cl. G06Q 10/08

(52) U.S. Cl. CPC G06Q 10/08355; G06Q 10/0836

(57) ABSTRACT

The disclosure generally pertains to systems and methods for providing a rendezvous service for pick-up or delivery. In an example method, a first request associated with a user of a vehicle may be received. The first request may comprise a delivery request or a pickup request. A first time for completing the first request may be determined. A predicted route associated with the vehicle may then be determined, where a first duration of the predicted route may include the first time. A first location for completing the first request may be selected, where the first location may be selected based at least in part on the first location being available at the first time. The first request may then be completed at the first location.

### BACKGROUND

Vehicle drivers may not be able to complete delivery and/or pick-up requests of goods and/or people in loading and/or unloading areas that are preferable to customers, such as areas with lower traffic levels. For example, a vehicle driver may presently have to park his or her vehicle on a street with high traffic levels and proceed to the delivery and/or pick-up location in order to complete a delivery and/or pick-up request. Further, companies providing delivery and/or pick-up options may be providing delivery and/or pick-up services directly to a customer's mailing address or a customer's present location, which reduces overall delivery efficiency and adds to traffic congestion when a customer receives multiple deliveries over a short period of time.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an example rendezvous service for pick-up or delivery in accordance with an embodiment of the disclosure.

FIG. 2 illustrates an example implementation of an existing rendezvous service for pick-up or delivery in accordance with an embodiment of the disclosure.

FIG. 3 illustrates an example implementation of a rendezvous service for pick-up or delivery in accordance with an embodiment of the disclosure.

FIG. 4 illustrates an example implementation of a rendezvous service for pick-up or delivery in accordance with an embodiment of the disclosure.

FIG. 5 illustrates an example implementation of a rendezvous service for pick-up or delivery in accordance with an embodiment of the disclosure.

FIG. 6 depicts a flow chart of an example method for utilizing a delivery assistance service having an augmented reality digital companion in accordance with the disclosure.

FIG. 7 depicts a block diagram of an example machine upon which any of one or more techniques (e.g., methods) may be performed, in accordance with an embodiment of the disclosure.

### DETAILED DESCRIPTION

### Overview

In terms of a general overview, certain embodiments described in this disclosure are directed to systems and methods for providing a rendezvous service for pick-up or delivery. In an example method, a first request associated with a user of a vehicle may be received. The first request may comprise a delivery request or a pickup request. A first time for completing the first request may be determined. A predicted route associated with the vehicle may then be determined, and the first duration of the predicted route may include the first time. A first location for completing the first request may be selected. The first location may be selected based at least in part on the first location being available at the first time. The first request may then be completed at the first location.

### Illustrative Embodiments

The disclosure will be described more fully hereinafter with reference to the accompanying drawings, in which example embodiments of the disclosure are shown. This disclosure may, however, be embodied in many different forms and should not be construed as limited to the example embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described example embodiments but should be defined only in accordance with the following claims and their equivalents. The description below has been presented for the purposes of illustration and is not intended to be exhaustive or to be limited to the precise form disclosed. It should be understood that alternate implementations may be used in any combination desired to form additional hybrid implementations of the present disclosure. For example, any of the functionality described with respect to a particular device or component may be performed by another device or component.

Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words and phrases are used herein solely for convenience and such words and terms should be interpreted as referring to various objects and actions that are generally understood in various forms and equivalencies by persons of ordinary skill in the art. For example, the phrase “vehicle driver” may be used interchangeably with the phrase “vehicle owner,” the word “customer,” and the word “driver.” Either word as used herein refers to any individual that is utilizing the rendezvous service. The word “device” may be any of various devices, such as, for example, a user device such as a smartphone or a tablet, a smart vehicle, and a computer.” The word “sensor” may be any of various sensors that can be found in a vehicle, such as cameras, radar sensors, Lidar sensors, and sound sensors.

It must also be understood that words such as “implementation,” “scenario,” “case,” and “situation” as used herein are an abbreviated version of the phrase “in an example (“implementation,” “scenario,” “case,” “approach,” and “situation”) in accordance with the disclosure.” Furthermore, the word “example” as used herein is intended to be non-exclusionary and non-limiting in nature.

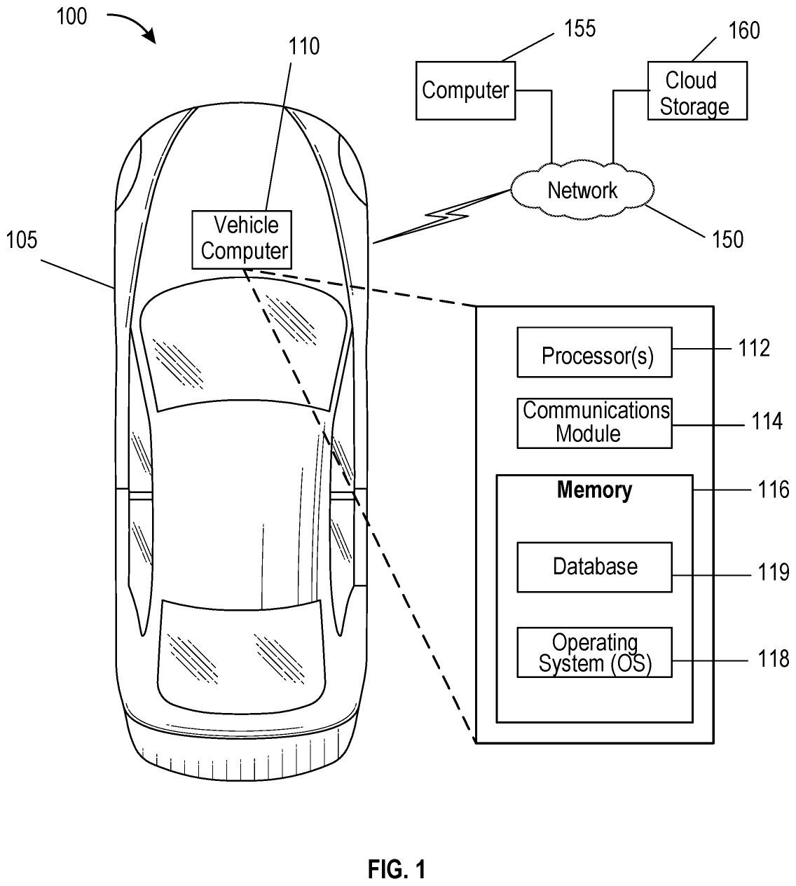

FIG. 1 illustrates an example rendezvous service 100 for pick-up or delivery in accordance with an embodiment of the disclosure. The rendezvous service 100 may be carried out by a vehicle 105, which may be any of various types of vehicles such as, for example, a gasoline powered vehicle, an electric vehicle, a hybrid electric vehicle, an autonomous vehicle, a sedan, a van, a minivan, a sports utility vehicle, a truck, a station wagon, or a bus. The rendezvous service 100 may be used to pick-up and/or deliver goods, or to pick-up and/or drop off people.

The vehicle 105 may further include components such as, for example, a vehicle computer 110. The vehicle 105 may further include various types of sensors and detectors configured to provide various functionalities. The vehicle computer 110 may perform various operations associated with the vehicle 105, such as controlling engine operations like turning the vehicle 105 on and off, fuel injection, speed control, emissions control, braking, and other engine operations.

In some embodiments, the vehicle computer 110 may include a processor 112, a communications module 114, and a memory 116. It must be understood that the communications module 114 is a functional block that can be implemented in hardware, software, or a combination thereof. An example hardware component may include a signal processor. An example software component may include a signal processing module. The processor 112 may carry out various operations by executing computer-readable instructions stored in the memory 116. The memory 116, which is one example of a non-transitory computer-readable medium, may be used to store a database 119 for storing data and an operating system (OS) 118.

In some embodiments, the vehicle computer 110 may be configured to include various components having functions associated with providing the rendezvous service 100. For example, the vehicle computer 110 may assist in determining predicted routes associated with the vehicle and selecting locations for completing delivery and/or pick-up requests. In an example embodiment, the vehicle computer 110 may be communicatively coupled to other components of the vehicle 105 via wired and/or wireless connections. More particularly, the vehicle computer 110 may be communicatively coupled to the vehicle 105 via a vehicle bus that uses a controller area network (CAN) bus protocol, a Media Oriented Systems Transport (MOST) bus protocol, and/or a CAN flexible data (CAN-FD) bus protocol. In another embodiment, the communications may be provided via wireless technologies such as Bluetooth®, Ultra-Wideband (UWB), cellular, Wi-Fi, ZigBee®, or near-field communications (NFC).

In some embodiments, the vehicle computer 110 is configured to communicate via a network 150 with devices located outside the vehicle 105, such as, for example, a computer 155 (a server computer, a cloud computer, etc.) and/or a cloud storage device 160.

The network 150 may include any one, or a combination of networks, such as, for example, a local area network (LAN), a wide area network (WAN), a telephone network, a cellular network, a cable network, a wireless network, and/or private/public networks such as the Internet. The network 150 may support any of various communications technologies, such as, for example, TCP/IP, Bluetooth®, near-field communication (NFC), Wi-Fi, Wi-Fi Direct, Ultra-Wideband (UWB), cellular, machine-to-machine communication, and/or man-to-machine communication.

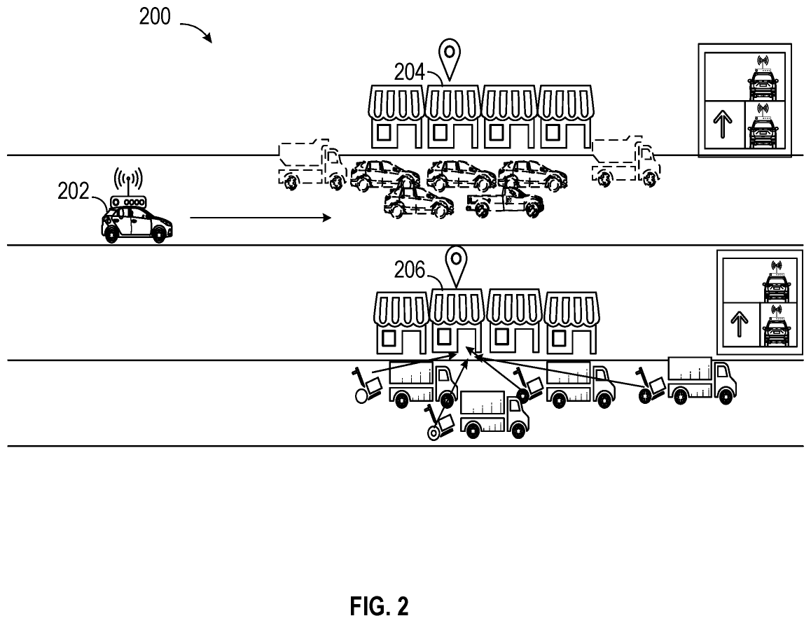

FIG. 2 illustrates an example implementation of an existing rendezvous service 200 for pick-up or delivery in accordance with an embodiment of the disclosure. The existing rendezvous service 200 may adopt two potential forms of pick-up or delivery services. In one example, the existing rendezvous service 200 may allow a delivery driver to provide goods for pick-up at a pick-up and/or delivery location 204, for example, a locker, a parking garage or parking lot, or a side lane on a street. A vehicle owner who is seeking to pick up the goods from the pick-up and/or delivery location 204 may then have to approach the pick-up and/or delivery location 204 in vehicle 202, exit the vehicle 202, proceed to the pick-up and/or delivery location 204, and pick up the goods. Alternatively, a vehicle owner who is seeking to deliver goods for another party to pick up may approach the pick-up and/or delivery location 204 in the vehicle 202 and drop off the goods at the pick-up and/or delivery location 204. Similarly, the vehicle owner will have to approach the pick-up and/or delivery location 204 via the vehicle 202, exit the vehicle 202, proceed to the pick-up and/or delivery location 204, and then drop off the goods. This may result in the vehicle owner having to park the vehicle 202 in a busy location and avoid traffic to reach the pick-up and/or delivery location 204.

In another example, the existing rendezvous service 200 may involve a customer that has transmitted at least one pick-up and/or delivery request. For example, the customer may have transmitted multiple orders for delivery to mailing address 206. In addition, the customer may have arranged for certain goods to be delivered from the mailing address 206, and the customer may assemble packages for a delivery vehicle to pick up from the mailing address 206. This may result in multiple delivery vehicles being configured to arrive at the mailing address over a short period of time.

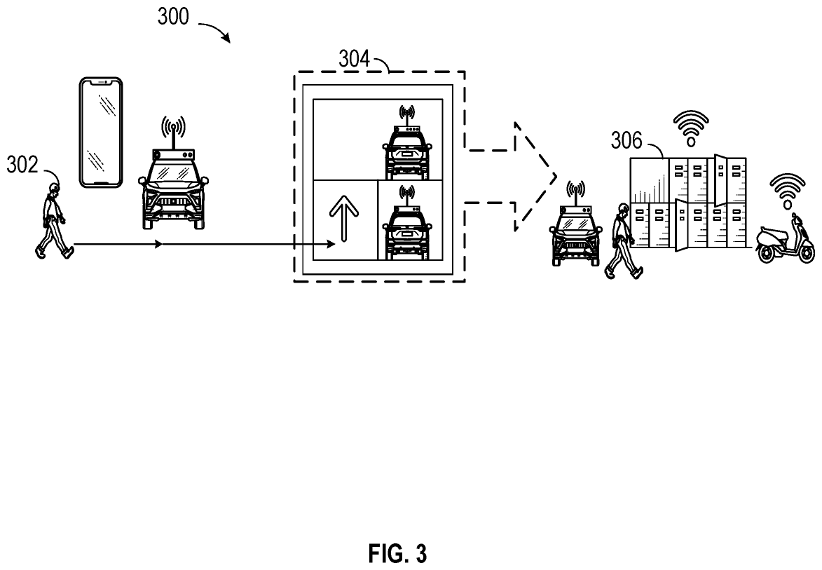

FIG. 3 illustrates an example implementation of a rendezvous service 300 for pick-up or delivery in accordance with an embodiment of the disclosure. In some embodiments, a vehicle owner 302 may be capable of picking a pick-up and/or delivery location 304 associated with the vehicle owner's 302 pick-up and/or delivery requests. In some instances, the vehicle owner 302 may make the selection of the pick-up and/or delivery location 304 via a mobile device associated with the user. In other instances, although not depicted in FIG. 3, a scheduling server may be used to determine the pick-up and/or delivery location 304 if the vehicle owner 302 does not opt to select the pick-up and/or delivery location 304.

In some embodiments, as depicted in FIG. 3, the pick-up and/or delivery location 304 may be a set of lockers 306 disposed in a parking garage. In other embodiments, the pick-up and/or delivery location 304 may include a pick-up and/or drop-off lane on a street. The vehicle owner 302 may use his or her vehicle to reach the pick-up or delivery location 304. Once the vehicle owner 302 has reached the pick-up and/or delivery location 304, the vehicle owner 302 may exit the vehicle and proceed to pick up or deliver the goods. For example, the goods may be disposed in a locker 306 within the parking garage. The vehicle owner 302 may be informed at the vehicle or via the mobile device to either pick up the goods from a particular locker 306 or to drop off the goods in a particular locker 306.

In some embodiments, although not depicted in FIG. 3, the pick-up and/or delivery location 304 may function as an intermediate pick-up and/or drop-off location for customers. For example, a customer may seek to travel to a destination. The customer may be assigned a vehicle for transportation to the destination. In some instances, the customer may desire to pick up or drop off other passengers on the way to the destination. For example, the customer may seek to pick up co-workers on the way to a job site or drop off co-workers on the way back from a job site, or the customer may seek to pick up friends on the way to the destination or drop off friends on the way back from the destination. In such embodiments, the pick-up and/or delivery location 304 may function as the intermediate pick-up and/or drop-off location. The rendezvous service 300 may select the pick-up and/or delivery location 304 as the intermediate pick-up and/or drop-off location, or the customer may select the pick-up and/or delivery location 304 as the intermediate pick-up and/or drop-off location. Once the intermediate pick-up and/or drop-off location has been determined, the rendezvous service 300 may instruct the customer and/or the other passengers that the pick-up and/or delivery location 304 may function as the intermediate pick-up and/or drop-off location. The other passengers may thus be notified to meet at the pick-up and/or delivery location 304 at a predetermined time in order to be picked up by the customer, or the other passengers may be notified that the ride-share process may terminate at the pick-up and/or delivery location 304.

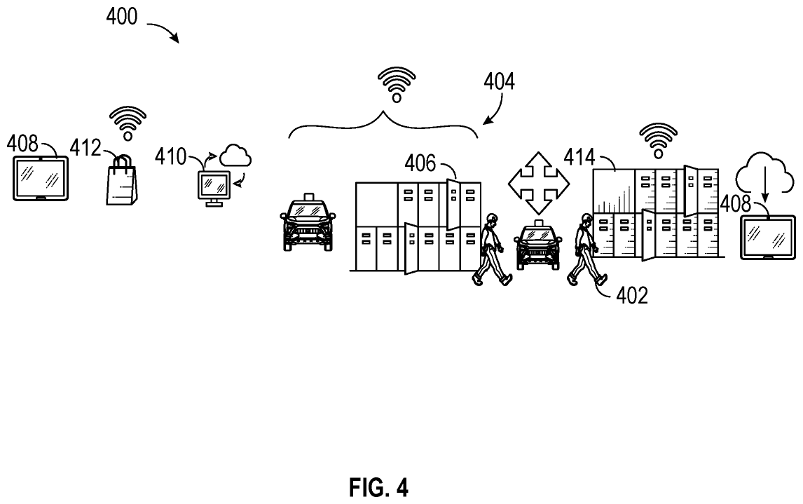

FIG. 4 illustrates an example implementation of a rendezvous service 400 for pick-up or delivery in accordance with an embodiment of the disclosure. In some embodiments, a vehicle owner 402 may be instructed to proceed to a set of lockers 406 located in pick-up and/or delivery location 404. With respect to FIG. 3, the vehicle owner 402 may be configured to select the set of lockers 406 as the pick-up and/or delivery location 404. This selection may be made at device 408, for example, a mobile device associated with the vehicle owner 402 or any other appropriate device. In other embodiments, a schedule server 410 having cloud communication capabilities may be configured to determine that the set of lockers 406 should be designated as the pick-up and/or delivery location 404. The schedule server 410 may be configured for access to a list of potential pick-up and/or delivery locations which have been previously registered to be pick-up and/or delivery locations, and the schedule server 410 may configured to be updated regarding availability at each registered pick-up and/or delivery locations as availability changes over time.

In some embodiments, the schedule server 410 may track the current locations of packages 412 associated with the vehicle owner's 402 pick-up and/or delivery requests in order to determine that the set of lockers 406 should be designated as the pick-up and/or delivery location 404. In some instances, the set of lockers 406 may be designated as the pick-up and/or delivery location 404 based at least in part on the projected route of the vehicle owner 402 and the timing of said projected route. In some instances, the set of lockers 406 may be designated as the pick-up and/or delivery location 404 further based at least in part on the availability of the set of lockers 406 at the time that the vehicle owner 402 is expected to be traveling along the projected route.

In some embodiments, the schedule server 410 may designate the set of lockers 406 as the pick-up and/or delivery location 404 based at least in part on the suitability of the pick-up and/or delivery location 404 for accommodating multiple pick-up and delivery requests associated with the vehicle owner 402. For example, if the vehicle owner 402 has placed two orders for pick-up, the schedule server 410 may select the set of lockers 406 because a first retailer delivering the first of the two orders and a second retailer delivering the second of the two orders are capable of delivering their respective orders to the set of lockers 406. Further, the schedule server 410 may designate the set of lockers 406 as the pick-up and/or delivery location 404 because the set of lockers 406 is physically available to contain both the orders until the vehicle owner 402 arrives for pick-up. Availability may be determined by sensors placed at the set of lockers 406 and/or usage algorithms used to complement vehicles. The usage algorithm may be created with the assistance of the sensors in order to predict pick-up and delivery location availabilities in such a manner as to prevent a queue at the pick-up and/or delivery location 404 when the vehicle owner 402 reaches the pick-up and/or delivery location 404.

In some embodiments, the schedule server 410 may be configured to detect if the vehicle owner 402 is traveling on an actual route that is different from the projected route. The schedule server 410 may be further configured to detect if the vehicle owner 402 may desire to pick up and/or deliver the goods at a different time than the initial projected time. For example, the vehicle owner 402 may seek a different pick-up and/or delivery time because the vehicle owner 402 is traveling on an actual route that is different from the projected route, because the vehicle owner 402 is traveling along a route at a different time than the predicted time, or because of any other reason. Additionally, there may be other reasons for the vehicle owner 402 to seek pick-up and/or delivery at a different location and/or a different time. In some embodiments, the schedule server 410 may be further configured to detect if packages associated with the vehicle owner's 402 pick-up and/or delivery requests may need to be re-routed to a different pick-up and/or delivery location due to changes in circumstances not associated with the vehicle owner 402. For example, there may be a change in availability at the set of lockers 406. In another example, the retailer fulfilling the pick-up and/or delivery request may be unable to fulfill the pick-up and/or delivery request at the set of lockers 406 at the particular time preferred by the vehicle owner 402. It should be noted that this list of reasons is not exclusive.

In such an embodiment, if the schedule server 410 has reassigned the vehicle owner 402 to fulfill the pick-up and/or delivery request at an alternative location 414, such as a different set of lockers, the schedule server 410 may communicate the change in pick-up and/or delivery location and/or time to the vehicle owner 402. The schedule server 410 may communicate this change via the device 408. In some embodiments, the schedule server 410 may be further configured to provide the vehicle owner 402 with periodic updates if an estimated time of arrival associated with packages 412 have changed. In some embodiments, the pick-up and/or delivery location 404 and/or the alternative location 414 may be configured with additional capabilities, such as wireless capabilities to enable communication with the schedule server 410 and/or devices 408 associated with the vehicle owner 402, charging stations for electric vehicles, bike racks, and providing lost-and-found services, in which the vehicle owner 402 may be able to retrieve a lost object that a third party has found and left at the pick-up and/or delivery location for pick-up by the vehicle owner 402. Other additional capabilities may include the use of sensors and/or cameras at each of the pick-up and/or delivery location 404 and the alternative location 414 in order to assist the schedule server 410 in collecting data regarding utilization of either location and traffic information at either location, and to assist in contacting emergency services (for example, medical personnel and/or law enforcement) should a need arise.

In some embodiments, the schedule server 410 may assist in scheduling cleaning appointments, inspections, data transfers, and other tasks in order to ensure the maintenance of each pick-up and/or delivery locations. In some cases, such tasks may be scheduled at times where each pick-up and/or delivery location is under-utilized, for example, late at night. In one embodiment, a locker at each pick-up and/or delivery location may be used to store equipment associated with said tasks in order to facilitate efficient execution of said tasks.

In some embodiments, each pick-up and/or delivery location may be clearly marked by signage and/or may be well-lit in order to facilitate the pick-up and/or delivery process. Further, in some embodiments, each pick-up and/or delivery location may be used as a rendezvous location for multi-modal mobility services. For example, a vehicle may reach a pick-up and/or delivery location, and the vehicle may then remain parked at the pick-up and/or delivery location, while the vehicle owner may pick up his or her next mode of transportation, for example, an electric scooter or a bicycle, and continue on the next leg of his or her journey.

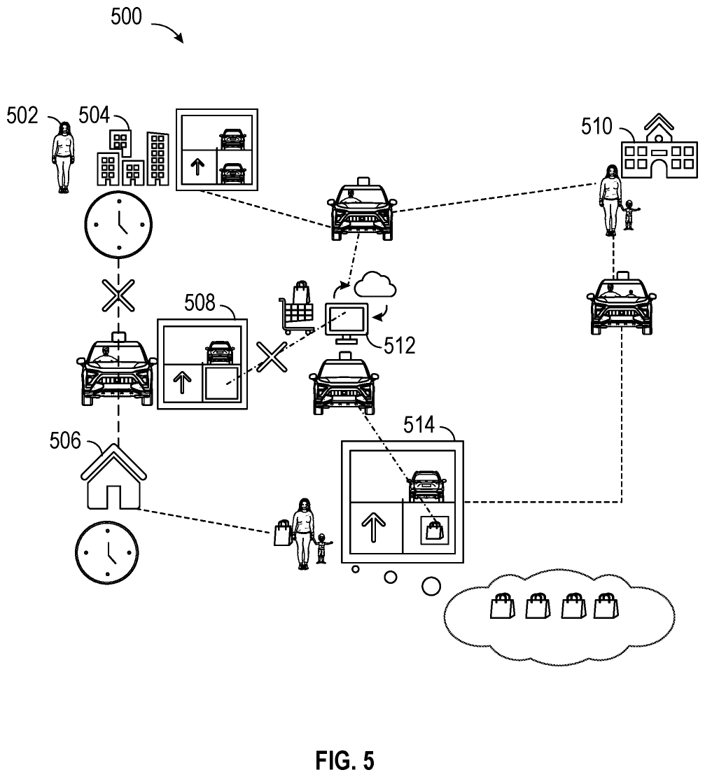

FIG. 5 illustrates an example implementation of a rendezvous service 500 for pick-up and/or delivery in accordance with an embodiment of the disclosure. For example, vehicle owner 502 leaves a first location 504 at an intended time. The vehicle owner 502 may have planned to return directly to his or her home 506 and pick up goods associated with the vehicle owner's 502 pickup request at a predicted pick-up and/or delivery location 508 along the route from the first location 504 to the home 506 after the intended time. However, as the vehicle owner 502 is about to leave the first location 504, the vehicle owner 502 may receive a notification that the vehicle owner 502 may have to pick his or her child up from school 510 before returning to the home 506. As a result, the vehicle owner 502 may no longer be traveling along the route from the first location 504 to the home 506, and, thus, picking up the goods from the predicted pick-up and/or delivery location 508 may no longer be desirable to the vehicle owner 502.

In some embodiments, the vehicle owner 502 may notify a schedule server 512 of the changes to the vehicle owner's 502 plans. In other embodiments, the schedule server 512 may detect that the vehicle owner's 502 plans have changed by detecting that the vehicle owner's 502 vehicle is not traveling along the route from the first location 504 to the home 506. In light of this change to the vehicle owner's 502 plans, the schedule server 512 may reassign the vehicle owner's 502 pick-up request to an actual pick-up and/or delivery location 514 that is along a route from the school 510 to the home 506. The reassignment may be communicated to a retailer that is fulfilling the vehicle owner's 502 pick-up request in order to enable the retailer to deliver the appropriate goods to the actual pick-up and/or delivery location 514 at an appropriate time for pick-up by the vehicle owner 502. In addition, the actual pick-up and/or delivery location 514 may be further assigned to be the pick-up and/or delivery location for any other pick-up and/or delivery requests made by the vehicle owner 502.

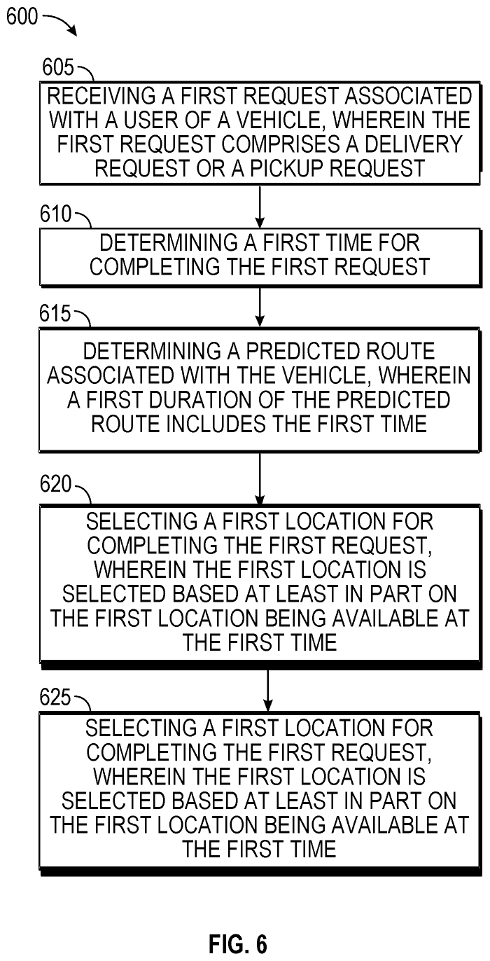

FIG. 6 shows a flow chart 600 of an example method of utilizing a rendezvous service for pick-up or delivery in accordance with the disclosure. The flow chart 600 illustrates a sequence of operations that can be implemented in hardware, software, or a combination thereof. In the context of software, the operations represent computer-executable instructions stored on one or more non-transitory computer-readable media such as a memory 126 provided in the vehicle computer 110, that, when executed by one or more processors such as the processor 122 provided in the vehicle computer 110, perform the recited operations. Generally, computer-executable instructions include routines, programs, objects, components, data structures, and the like that perform particular functions or implement particular abstract data types. The order in which the operations are described is not intended to be construed as a limitation, and any number of the described operations may be carried out in a different order, omitted, combined in any order, and/or carried out in parallel. Some or all of the operations described in the flow chart 600 may be carried out by the vehicle computer 110 either independently or in cooperation with other devices such as, for example, other components of the vehicle 105 and cloud elements (such as, for example, the computer 155 and cloud storage 160.

At block 605, a first request associated with a user of a vehicle may be received. In some embodiments, the first request may include a delivery request or a pickup request. In some embodiments, a second request associated with the user of the vehicle may be received.

At block 610, a first time for completing the first request may be determined.

At block 615, a predicted route associated with the vehicle may be determined. The first duration of the predicted route may include the first time.

At block 620, a first location for completing the first request may be selected. The first location may be selected based at least in part on the first location being available at the first time. In some embodiments, if the second request has been received, the first location may be selected to complete both the first request and the second request. In some embodiments, a usage algorithm may be used to determine whether the first location is available at the first time. In some embodiments, the first location may comprise a locker or a pick-up or drop-off lane. In some embodiments, the first location for completing the first request may be selected further based at least in part on the first location being located along the predicted route.

At block 625, the first request may be completed at the first location. In some embodiments, if the first location has been selected to complete the second request, the second request may further be completed at the first location. In some embodiments, an actual route associated with the vehicle may be determined, where the actual route is different from the predicted route. A second duration of the actual route may include the first time. In such an embodiment, a second location for completing the first request may be selected, where the second location is selected based at least in part on the second location being available at the first time and the second location being located along the actual route.

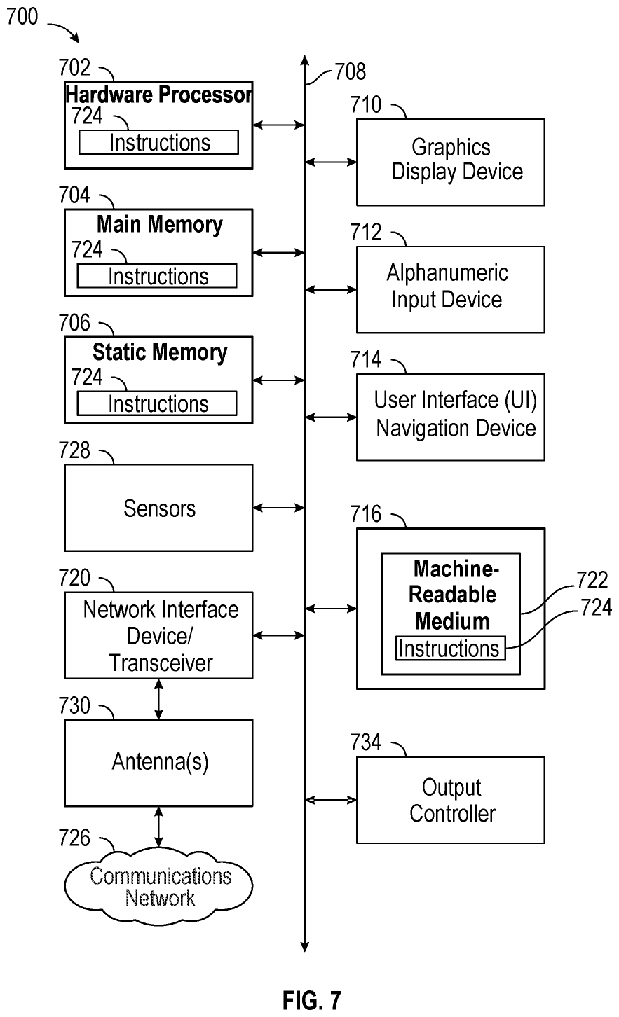

FIG. 7 depicts a block diagram of an example machine 700 upon which any of one or more techniques (e.g., methods) may be performed, in accordance with one or more example embodiments of the present disclosure. In other embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environments. The machine 700 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. In some embodiments, the machine 700 may be the vehicle 105, as depicted in FIG. 1. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the execution units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a graphics display device 710, an alphanumeric input device 712 (e.g., a keyboard), and a user interface (UI) navigation device 714. In an example, the graphics display device 710, the alphanumeric input device 712, and the UI navigation device 714 may be a touch screen display. The machine 700 may additionally include a storage device (i.e., drive unit) 716, a network interface device/transceiver 720 coupled to antenna(s) 730, and one or more sensors 728, such as a global positioning system (GPS) sensor, a compass, an accelerometer, or other sensor. The machine 700 may include an output controller 734, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within the static memory 706, or within the hardware processor 702 during execution thereof by the machine 700. In an example, one or any combination of the hardware processor 702, the main memory 704, the static memory 706, or the storage device 716 may constitute machine-readable media.

While the machine-readable medium 722 is illustrated as a single medium, the term “machine-readable medium” may include a single medium or multiple media (e.g., a centralized or distributed database, and/or associated caches and servers) configured to store the one or more instructions 724.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 700 and that cause the machine 700 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device/transceiver 720 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 720 may include one or more physical jacks (e.g., Ethernet, coaxial, or phone jacks) or one or more antennas to connect to the communications network 726. In an example, the network interface device/transceiver 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 700 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee®, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize one or more devices that include hardware, such as, for example, one or more processors and system memory, as discussed herein. An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, such as the processor 122, cause the processor to perform a certain function or group of functions. The computer-executable instructions may be, for example, binaries, intermediate format instructions, such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

A memory device, such as the memory 126, can include any one memory element or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, the memory device may incorporate electronic, magnetic, optical, and/or other types of storage media. In the context of this document, a “non-transitory computer-readable medium” can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). Note that the computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein for purposes of illustration and are not intended to be limiting. Embodiments of the present disclosure may be implemented in further types of devices, as would be known to persons skilled in the relevant art(s).

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described example embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey the information that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
receiving a first request associated with a user of a vehicle, wherein the first request comprises a delivery request or a pickup request;
determining a first time for completing the first request;
determining a predicted route associated with the vehicle, wherein a first duration of the predicted route includes the first time;
selecting a first location for completing the first request, wherein the first location is selected based at least in part on the first location being available at the first time; and
completing the first request at the first location.

2. The method of claim 1, further comprising:
receiving a second request associated with the user of the vehicle;
selecting the first location for completing the first request and the second request; and
completing the first request and the second request at the first location.

3. The method of claim 1, wherein the first location comprises a locker or a pickup or drop-off lane.

4. The method of claim 1, wherein the first location for completing the first request is selected further based at least in part on the first location being located along the predicted route.

5. The method of claim 1, further comprising:
determining an actual route associated with the vehicle, wherein the actual route is different from the predicted route, and wherein a second duration of the actual route includes the first time.

6. The method of claim 5, further comprising:
selecting a second location for completing the first request, wherein the second location is selected based at least in part on the second location being available at the first time and the second location being located along the actual route.

7. The method of claim 1, wherein a usage algorithm is used to determine whether the first location is available at the first time.

8. A device, comprising:
at least one memory device that stores computer-executable instructions; and
at least one processor configured to access the at least one memory device, wherein the at least one processor is configured to execute the computer-executable instructions to:
receive a first request associated with a user of a vehicle, wherein the first request comprises a delivery request or a pickup request;
determine a first time for completing the first request;
determine a predicted route associated with the vehicle, wherein a first duration of the predicted route includes the first time;
select a first location for completing the first request, wherein the first location is selected based at least in part on the first location being available at the first time; and
complete the first request at the first location.

9. The device of claim 8, wherein the at least one processor is further configured to execute the computer-executable instructions to:
receive a second request associated with the user of the vehicle;
select the first location for completing the first request and the second request; and
complete the first request and the second request at the first location.

10. The device of claim 8, wherein the first location comprises a locker or a pickup or drop-off lane.

11. The device of claim 8, wherein the first location for completing the first request is selected further based at least in part on the first location being located along the predicted route.

12. The device of claim 8, wherein the at least one processor is further configured to execute the computer-executable instructions to:
determine an actual route associated with the vehicle, wherein the actual route is different from the predicted route, and wherein a second duration of the actual route includes the first time.

13. The device of claim 12, wherein the at least one processor is further configured to execute the computer-executable instructions to:
select a second location for completing the first request, wherein the second location is selected based at least in part on the second location being available at the first time and the second location being located along the actual route.

14. The device of claim 8, wherein a usage algorithm is used to determine whether the first location is available at the first time.

15. A non-transitory computer-readable medium storing computer-executable instructions which, when executed by a processor, cause the processor to perform operations comprising:
receiving a first request associated with a user of a vehicle, wherein the first request comprises a delivery request or a pickup request;
determining a first time for completing the first request;
determining a predicted route associated with the vehicle, wherein a first duration of the predicted route includes the first time;
selecting a first location for completing the first request, wherein the first location is selected based at least in part on the first location being available at the first time; and
completing the first request at the first location.

16. The non-transitory computer-readable medium of claim 15, wherein the operations further comprise:
receiving a second request associated with the user of the vehicle;
selecting the first location for completing the first request and the second request; and
completing the first request and the second request at the first location.

17. The non-transitory computer-readable medium of claim 15, wherein the first location comprises a locker or a pickup or drop-off lane.

18. The non-transitory computer-readable medium of claim 15, wherein the first location for completing the first request is selected further based at least in part on the first location being located along the predicted route.

19. The non-transitory computer-readable medium of claim 15, wherein the operations further comprise:
determining an actual route associated with the vehicle, wherein the actual route is different from the predicted route, and wherein a second duration of the actual route includes the first time.

20. The non-transitory computer-readable medium of claim 19, wherein the operations further comprise:
selecting a second location for completing the first request, wherein the second location is selected based at least in part on the second location being available at the first time and the second location being located along the actual route.
